(19) United States
(12) Patent Application Publication
(10) Pub. No.: US 2018/0038545 A1
(43) Pub. Date: Feb. 8, 2018

(54) TUBE DEVICES AND TRIPODS

(71) Applicant: Huiyun MA, Shenzhen (CN)

(72) Inventor: Huiyun MA, Shenzhen (CN)

(21) Appl. No.: 15/245,115

(22) Filed: Aug. 23, 2016

(30) Foreign Application Priority Data
Aug. 5, 2016 (CN) 201610640204.0

(51) Int. Cl. F16M 11/32; F16B 7/10; G03B 17/56; F16B 7/14

(52) U.S. Cl. CPC F16M 11/32; F16B 7/1427; F16B 7/105; G03B 17/561

(57) ABSTRACT

A tube device includes a first tube, a second tube sleeved to the first tube, and a locking member assembled in a sleeve connection position between the first tube and the second tube and received in the second tube. The first tube is received in the second tube. When the first tube is rotated, the first tube drives the locking member to abut against an inner wall of the second tube until the first tube and the second tube are in a locking position.

### BACKGROUND

### 1. Technical Field

The present disclosure generally relates to articles for daily life, and especially relates to a tube device and a tripod.

### 2. Description of Related Art

In daily life, people often need to use a camera to take pictures. In order to get good photo, the camera is placed on a tripod. Often, the tripod includes a plurality of tube devices, and each of the tube devices includes a plurality tubes and a plurality of locking members. A tube is sleeved to another tube by one locking members engaged to an outer face of the one tube, resulting in accident damage of the locking member during the use of the tube device.

### SUMMARY

The disclosure relates to a tube device and a tripod.

In one aspect, a tube device includes: a first tube, a second tube sleeved to the first tube, and a locking member assembled in a sleeve connection position between the first tube and the second tube and received in the second tube. Wherein the first tube is received in the second tube, and wherein when the first tube is rotated, the first tube drives the locking member to abut against an inner wall of the second tube until the first tube and the second tube are in a locking position.

Wherein the locking member comprises a protruding portion having a variation thickness, and the first tube defines a first recessing portion for receiving the protruding portion; wherein when the protruding portion is received in the first recessing portion, the second tube can move relative to the first tube, thereby adjusting a length between the second tube and the first tube, and wherein when the first is rotated, the first tube drives the protruding portion to gradually disengage from the first recessing portion and to abut against the inner wall of the second tube until the first tube and the second tube are in the locking position.

Wherein locking member comprising: a locking plate comprising a protruding portion having a variation thickness, wherein the first tube defines a receiving groove located in first end thereof, and wherein when the protruding portion is placed in the receiving groove, the protruding portion protrudes out of the receiving groove; and a locking base fixed to the first tube and defining a second recessing portion in communication with the receiving groove, wherein the locking plate is received in the second recessing portion; wherein when the first is rotated, the first tube drives the locking base to rotate, and the locking base drives the protruding portion to gradually disengage from the second recessing portion and to abut against the inner wall of the second tube until the first tube and the second tube are in the locking position.

Wherein the tube device comprises a locating portion to fix the locking base to the first tube, wherein the locating portion comprises a locating bar positioned in an inner surface of the first tube and a locating groove positioned in an outer surface of the locking base to receive the locating bar.

Wherein a first hole is defined in a second end of the first tube, and a second hole is defined in an end of the second tube, when the first tube is sleeved to the second tube and the second tube moves from the first end to the second end of the first tube, the first hole is in communication with the second hole.

Wherein the tube device comprises a fixing portion defining a fixing hole, wherein when the fixing portion is inserted into the second tube, the second hole is corresponding to the fixing hole.

Wherein the fixing portion defines a slot, and the second tube comprises a fixing block protruding out of an inner surface of the second tube, wherein the fixing block is received in the slot.

Wherein he locking base comprises an inserting portion locating on an end thereof, and a limiting portion locating another end thereof, wherein when the inserting portion is inserted into the first tube, the limiting portion flushes with an end face of the first tube adjacent to the receiving groove.

Wherein the limiting portion defines a third hole in order that atmosphere enters into the tube device.

In another aspect, a tripod includes a placing plate and a plurality of tube devices engaged to the placing plate, each of the plurality of tube devices is similar to the above the tube device.

Compared to the prior art, the technical effect of the invention is that the locking member is received in the second tube so that the locking member is not exposed to an outside, thereby preventing accidental damage, and having advantages of easy operation and convenient collection.

### BRIEF DESCRIPTION OF THE DRAWINGS

FIG. 1 is an assembled view of a locking member and a first tube of a first embodiment of the present invention;

FIG. 2 is an exploded view of a locking base of the locking member inserted into the first tube, a pair of locking plates, and the first tube of the first embodiment of the present invention;

FIG. 3 is an exploded view of the locking member and the first tube of the first embodiment of the present invention;

FIG. 4 is an assembled view of the first tube and the second tube of the first embodiment of the present invention, and the locking member is in an unlocking position;

FIG. 5 is similar to FIG. 4, but the locking member is in an locking position;

FIG. 6 is an exploded view of the first tube, the second tube, and the locking member of the first embodiment of the present invention;

FIG. 7 is a perspective view of the first tube of the first embodiment of the present invention;

FIG. 8 is a perspective view of the second tube of the first embodiment of the present invention;

FIG. 9 is a perspective view of the locking plate of the first embodiment of the present invention;

FIG. 10 is a perspective view of the locking base of the first embodiment of the present invention;

FIG. 11 is a perspective view of a fixing portion of the first embodiment of the present invention;

FIG. 12 is an exploded view of a locking member and a first tube of a second embodiment of the present invention; and

FIG. 13 is an assembled view of a tripod of the present invention.

### DETAILED DESCRIPTION

The disclosure is illustrated by way of example and not by way of limitation in the figures of the accompanying drawings, in which like reference numerals indicate similar elements. The embodiments described in accordance with the drawings are only examples, and thus the claimed invention is not limited thereto.

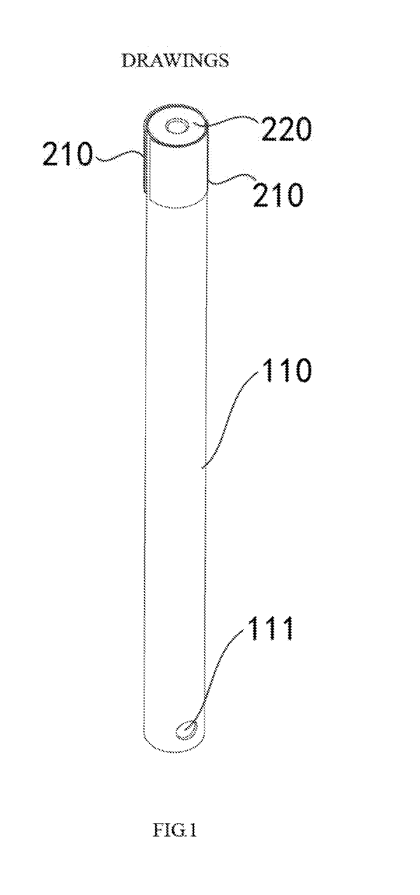

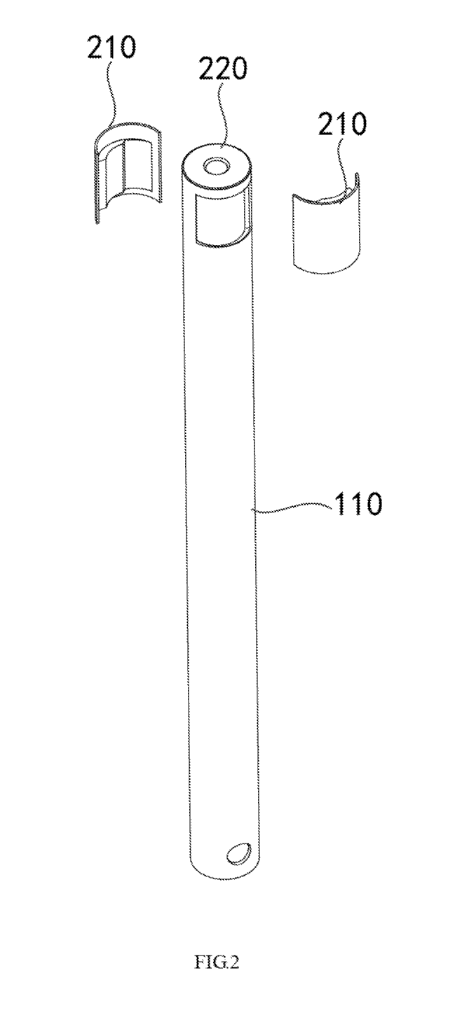

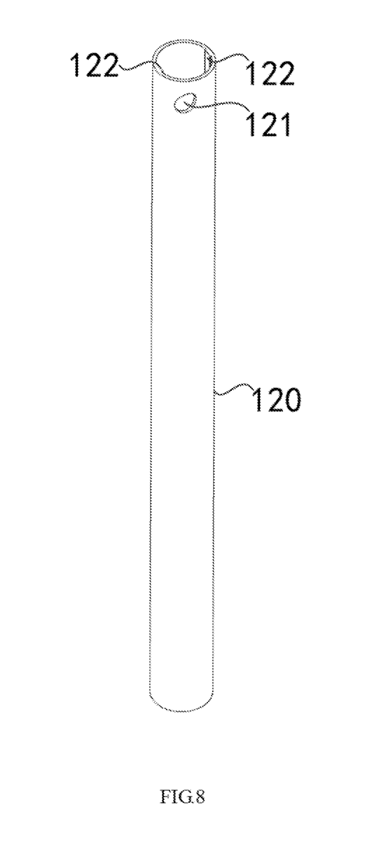

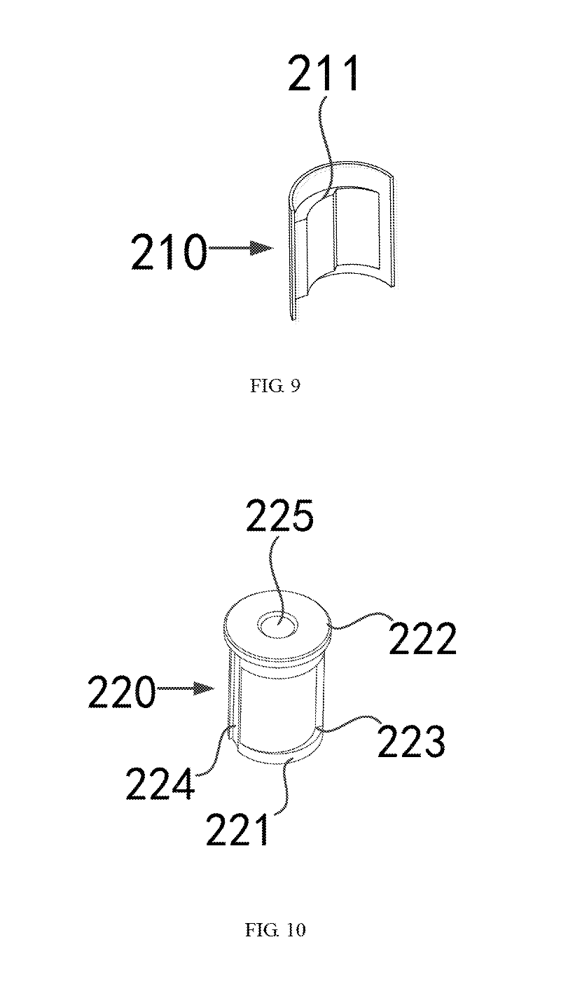

Referring to FIG. 1 to FIG. 11, a tube device 100 is disclosed. The tube device 100 is used to, but not limited to, a tripod, a monopod, a selfie stick, and other produces including one or a plurality of tubes.

The tube device 100 includes a first tube 110, a second tube 120, and a locking member 200.

The first tube 110 is sleeved to the second tube 120 and is received in the second tube 120. When the first tube 110 is inserted into the second tube 120, the first tube 110 can move in the second tube 120. That is to say, when the second tube 120 is sleeved to the first tube 110, the second tube 120 can be drawn freely relative to the first tube 110.

The locking member 200 is assembled in a sleeve connection position between the first tube 110 and the second tube 120, and is received in the second tube 120. When the first tube 110 is rotated, the first tube 110 drives the locking member 200 to abut against an inner wall of the second tube 120 until the first tube 110 and the second tube 120 are in a locking position.

In one embodiment, the locking member 200 is used to lock the first tube 110 and the second tube 120, and the first tube 110 is sleeve in the second tube 120. That is to say, the first tube 110 is inserted into the second tube 120, the second tube 120 can be drawn relative to the first tube 110.

In other embodiment, the tube device 100 includes a plurality of tubes, and one tube is sleeve to another tube by a locking member, for example, a first tube is sleeve to a second tube by a first locking member, the second tube is sleeve to a third tube by a second locking member, the third tube is sleeved to a fourth tube by a third locking member, and so on.

In assemble, the locking member 200 is received in the second tube 120, and the first tube 110 is sleeve to the second tube 120 by the locking member 200. In use, the first tube 110 is rotated along a first direction, and the first tube 110 drives the locking member 200 to abut against an inner wall of the second tube 120 until the first tube 110 and the second tube 120 are in a locking position. During the first tube 110 being rotated, the force applied on the locking member 200 is gradually increased, and the force applied on the inner wall of the second tube 120 is gradually increased, so that the second tube 120 is sleeved to the first tube 110 and cannot be drawn relative to the first tube 110. Thus, when the first tube 110 and the second tube 120 is fixed, the tube device 100 can be used to a supporting device.

When the tube device 100 need to be collection, the first tube 110 is rotated along a second direction opposite to the first direction, the force applied on the locking member 200 is gradually disappeared, and the force applied on the inner wall of the second tube 120 is gradually disappeared, until the second tube 120 can be drawn relative to the first tube 110, so that the first tube 110 can be received in the second tube 120, resulting in decreasing occupancy space and convenient transportation.

In addition, the locking member 200 is received in the second tube 120, and is not exposed to the outside, so that the locking member 200 is prevented from accidental damage. And the locking member 200 of the present invention has the advantages of easy operation and convenient collection.

Referring to FIG. 1 to FIG. 11, the locking member 200 includes at least one locking plate 210 and a locking base 220.

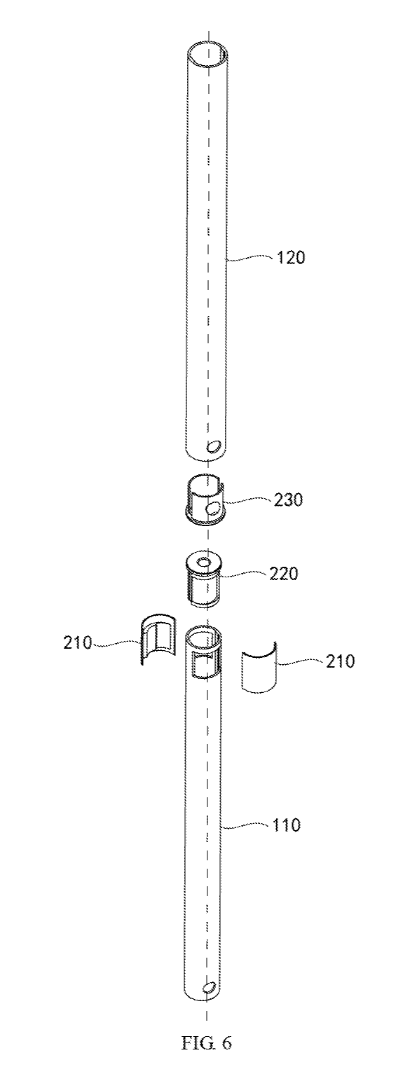

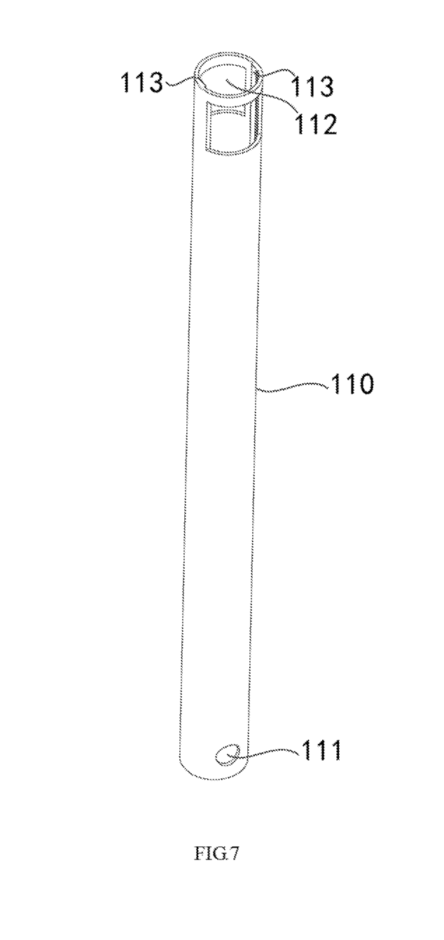

Referring to FIG. 1, FIG. 6, FIGS. 7-9, and FIG. 11, the locking plate 210 includes a protruding portion 211 having a variation thickness. The first tube 110 defines a receiving groove 112 locating a first end thereof. When the locking plate 210 is placed in the receiving groove 112, the protruding portion 211 protrudes out of the receiving groove 112. In detail, a part of the protruding portion 211 protrudes from the first tube 110 toward the inner wall of the second tube 120 through the receiving groove 112.

The locking base 220 is fixed to the first tube 110. The locking base 220 defines a second recessing portion 223 for receiving the protruding portion 211. A bottom wall of the second recessing portion 223 has a variation thickness in order to receive the protruding portion 211.

When the first tube 110 is rotated, the first tube 110 drives to the locking base 220 to rotate and the protruding portion 211 to gradually disengage from the second recessing portion 223 of the locking base 220, so that the protruding portion 211 moves to the inner wall of the second tube 120 and abuts against the inner wall of the second tube 120, and the first tube 110 and second tube 120 are locked in the locking position by the locking member 200.

In one embodiment, the locking base 200 is fixed to the first tube 110. The first tube 110 is rotated to drive the locking base 220 to rotate. The first tube 110 together with the locking base 220 drive the locking plate 210 to move so that the protruding portion 211 of the locking plate 210 is gradually disengaged from the second recessing portion 223 and abuts against the inner wall of the second tube 120 until the first tube 110 and the second tube 120 are locked in the locking position. During the first tube 110 being rotated, the force applied on the locking plate 210 by the first tube 110 and the locking base 220 is gradually increased, and the force applied on the inner wall of the second tube 120 by the locking plate 210 is gradually increased, until the second tube 120 is positioned by the locking plate 210, thus a length between the second tube 120 and the first tube 110 is freely adjusted, thereby making the use convenient. In addition, the friction force and contact area between the locking plate 210 and the inner wall of the second tube 120 is greater than the friction force and contact area between the protruding portion 211 and the inner wall of the second tube 120, thus the positioning effect of the second tube 120 is better, the locking effect between the first tube 110 and the second tube 120 is better.

The thickness of the protruding portion 211 is thickened gradually from one side of the locking plate 210 to another side of the locking plate 210. That is to say, the thickness of the protruding portion 211 is changed along with the circumferential direction of an inner surface of the first tube 110, so that the first tube 110 is rotated easily and cannot be stopped. In addition, the thickness of the second recessing portion 223 is corresponding to the thickness of the protruding portion 211 in order that the protruding portion 211 is received in the second recessing portion 223.

In one embodiment, the locking member includes a pair of locking plates 210. Each of the pair of locking plate 210 includes a protruding portion having a variation thickness. The first tube 110 defines a pair of receiving grooves 112 for placing the locking plates 210. The locking base 220 defines a pair of second recessing portions 223 to receive the locking plates 210.

In another embodiment, the number of the locking plate 210 is three, correspondingly, the number of the receiving groove 112 is three, and the number of the second recessing portion 223 is three.

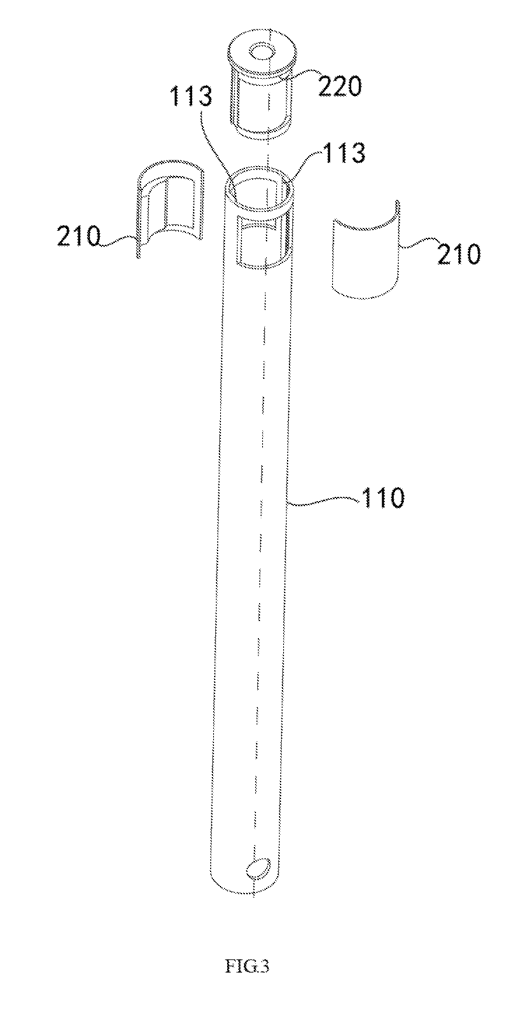

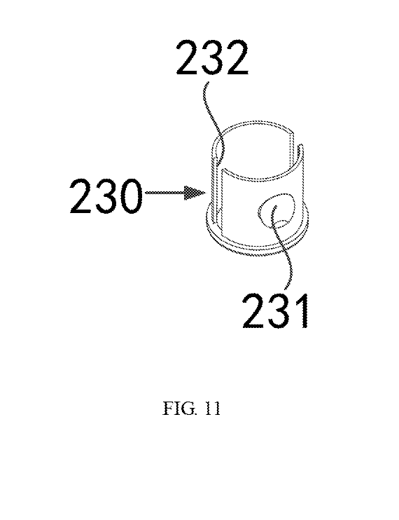

Referring to FIG. 3 and FIG. 10, the locking member 200 comprises a locating portion to fix the locking base 220 to the first tube 110. The locating portion comprises a locating bar 113 positioned in an inner surface of the first tube 110 and a locating groove 224 positioned in an outer surface of the locking base 220 to receive the locating bar 113. That the locating bar 113 is received in the locating groove 224 to prevent the locking base 220 from rotating relative to the first tube 110.

In another embodiment, the locating portion comprises a locating bar positioned in an inner surface of the locking base and a locating groove positioned in an outer surface of the first tube to receive the locating bar.

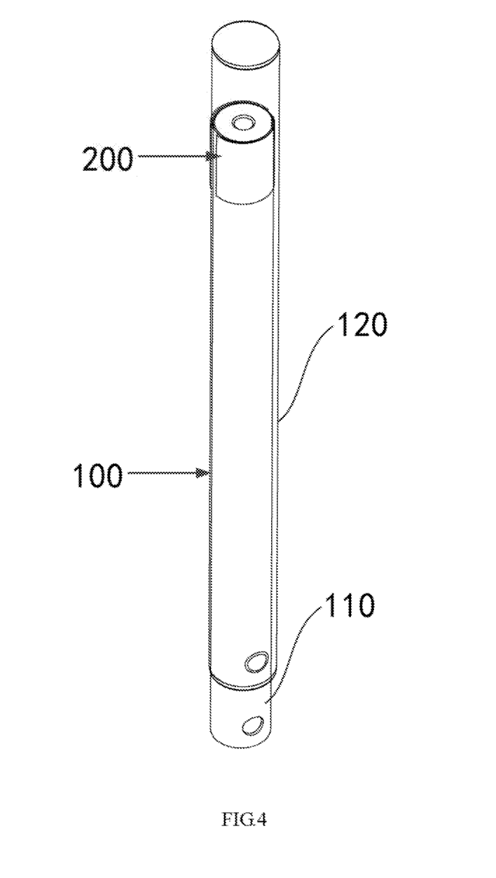

Referring to FIGS. 4-8, a first hole 111 is defined in a second end of the first tube 110, and a second hole 121 is defined an end of the second tube 120. When the first tube 110 is sleeved to the second tube 120, and the second tube 120 moves from the first end of the first tube 110 to the second end of the first tube 110, the first hole 112 is in communication with the second hole 121. When the first tube 110 and the second tube 120 are collected, the locking member 200 is in an unlocking position so that the second tube 120 can be drawn relative to the first tube 110, and the second tube 120 and the first tube 110 are assembled by a fixing structure, for example a rope, passing through the first hole 111 and the second hole 121.

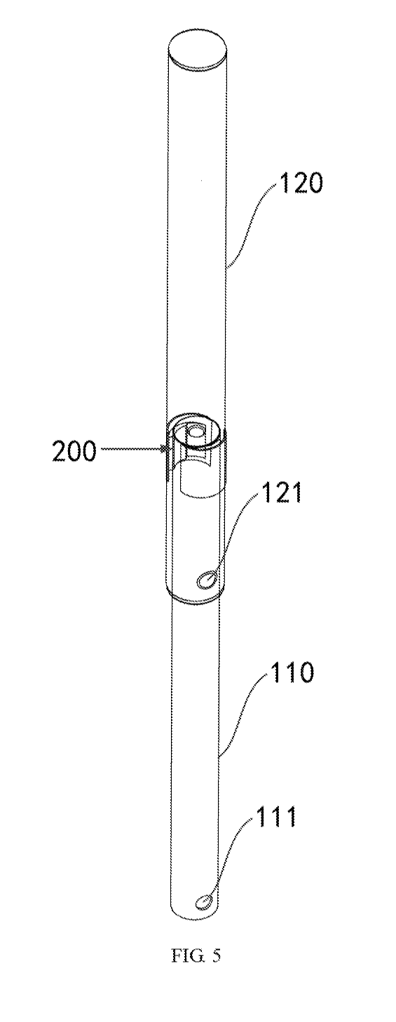

Referring to FIGS. 5-7 and FIG. 10, the locking base 210 includes an inserting portion 221 locating on an end thereof, and a limiting portion 222 locating another end thereof. When the inserting portion 221 is inserted into the first tube 110, the limiting portion 222 flushes with an end face of the first tube 110 adjacent to the receiving groove 112. The limiting portion 222 defines a third hole 225 in order that atmosphere can enter into the tube device 100, thereby preventing the pressure resistance.

Referring to FIGS. 5-8 and FIG. 11, the locking member 200 includes a fixing portion 230. The fixing potion 230 defines a fixing hole 231 in communication with the second hole 121 when the fixing portion is engaged to the second tube 120. In one embodiment, the fixing portion 230 is fixed in the second tube 120 through injection molding. When the fixing portion 230 is fixed in the second tube 120, the first tube 110 together with the locking member 200 cannot be accidentally disengaged from the second tube 120, a strength of the second tube 120 is increased so that the second tube 120 is prevented from cracking during the second tube 120 being sleeved to the first tube 110 or the first tube 110 and the second tube 120 being in the locking position.

In other embodiment, when the tube device includes a plurality tubes, and the number of tubes is more than 2, for example 4, in addition to a first tube, the second and third tubes also includes the fixing portion.

The fixing portion 230 defines a slot 232, and the second tube 120 comprises a fixing block 122 protruding out of an inner surface of the second tube 120. The fixing block 122 is received in the slot 232 in order to locate the second tube 120 and the fixing portion 230.

In one embodiment, a diameter of the second tube 120 is greater than a diameter of the first tube 110.

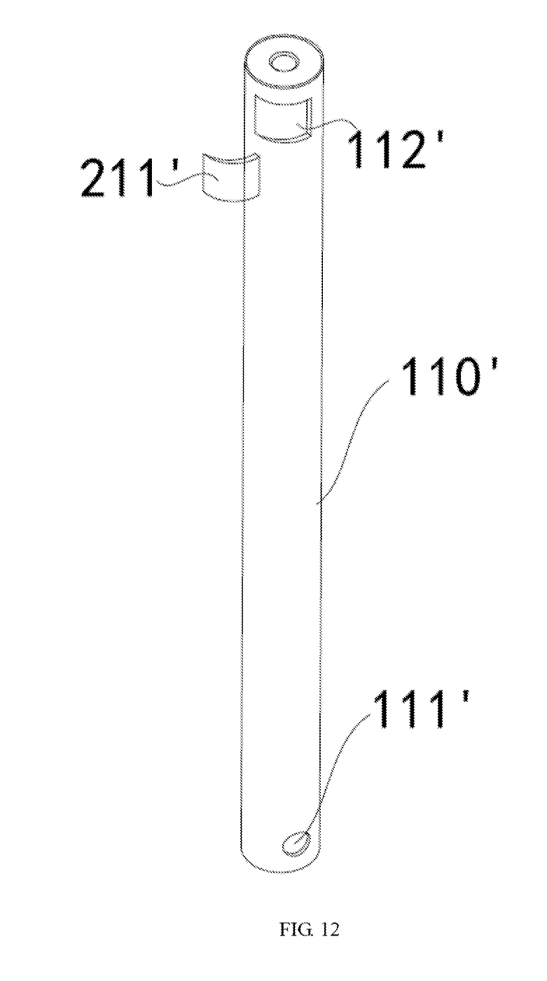

FIG. 12 discloses an exploded view of a locking member and a first tube of a second embodiment of the present invention. In the embodiment, the locking member includes a protruding portion 211′ having a variation thickness, and the first tube 110′ defines a first recessing portion 112′ to position the protruding portion 211′. A bottom wall of the first recessing portion 112′ has a variation thickness corresponding to the thickness of the protruding portion 211′.

In assemble, the protruding portion 211′ is received in the first recessing portion 112′, and the first tube 110′ is sleeved to the second tube 120 by the protruding portion 211′. In use, when the protruding portion 211′ is received in the first recessing portion 112′, the second tube 120 can be drawn relative to the first tube 110′ so that a length between the second tube 120 and the first tube 110′ is freely adjusted. When the first tube 110′ is rotated, and the first tube 110′ drives protruding portion 211′ to gradually disengage from the first recessing portion 112′ and abut against an inner wall of the second tube 120 until the first tube 110′ and the second tube 120 are in a locking position. During the first tube 110′ being rotated, the force applied on the protruding portion 211′ by the first tube 110′ is gradually increased, and the force applied on the inner wall of the second tube 120 by the protruding portion 211′ is gradually increased, until the second tube 120 is positioned by the protruding portion 211′, thus a length between the second tube 120 and the first tube 110′ is freely adjusted, thereby making the use convenient.

Other structure of the first tube 110′ is similar to the structure of the first tube 110, for example, the first tube 110′ includes a first hole 111′.

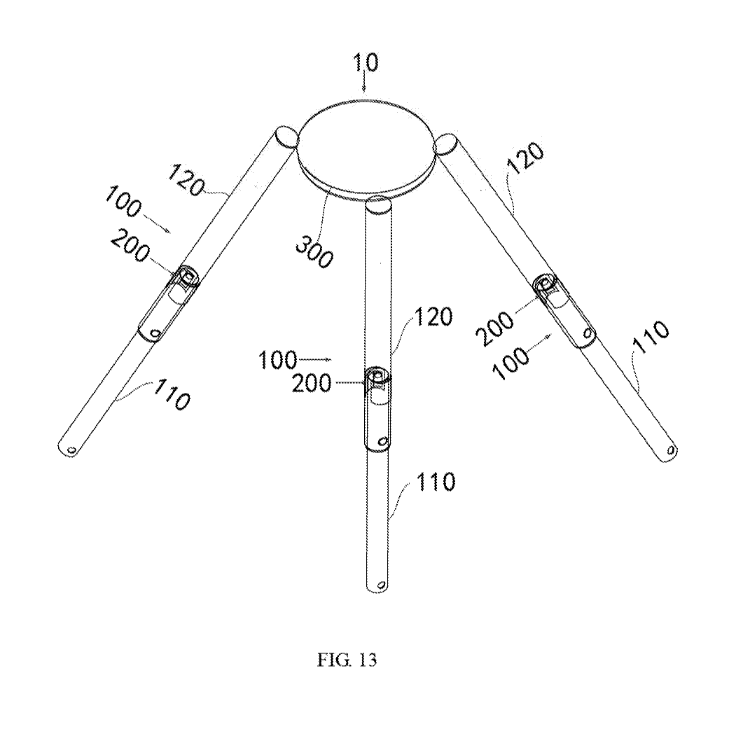

FIG. 13 discloses an assembled view of a tripod 10 of the present invention. Referring also to FIGS. 1-12, the tripod 10 includes a plurality of tube devices 100 and a placing plate 300. The plurality of tube devices 100 are fixed to the placing plate 300.

Each of the plurality of tube devices 100 includes a first tube 110, a second tube 120, and a locking member 200. The first tube 110 and the second tube 120 are in the locking position by the locking member 200 abutting against the inner wall of the second tube 120.

In another embodiment, the tripod 10 can be a monopod, a selfie stick, and other produces including one or a plurality of tubes.

In other embodiment, each of the plurality of the tube devices includes a plurality of tubes, and one tube is sleeve to another tube by a locking member, for example, a first tube is sleeve to a second tube by a first locking member, the second tube is sleeve to a third tube by a second locking member, the third tube is sleeved to a fourth tube by a third locking member, and so on.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

1. A tube device, comprising:
a first tube;
a second tube sleeved to the first tube, wherein the first tube is received in the second tube; and
a locking member assembled in a sleeve connection position between the first tube and the second tube and received in the second tube;
wherein when the first tube is rotated, the first tube drives the locking member to abut against an inner wall of the second tube until the first tube and the second tube are in a locking position;
wherein the locking member comprises:
a locking plate comprising a protruding portion having a variation thickness, wherein the first tube defines a receiving groove located in first end thereof, and wherein when the locking plate is placed in the receiving groove, the protruding portion protrudes out of the receiving groove; and
a locking base fixed to the first tube and defining a second recessing portion in communication with the receiving groove, wherein the protruding portion is received in the second recessing portion;
wherein when the first tube is rotated, the first tube drives the locking base to rotate, and the locking base drives the protruding portion to gradually disengage from the second recessing portion and to abut against the inner wall of the second tube until the first tube and the second tube are in the locking position.

2. The tube device of claim 1, wherein the locking member comprises a protruding portion having a variation thickness, and the first tube defines a first recessing portion for receiving the protruding portion; wherein when the protruding portion is received in the first recessing portion, the second tube can move relative to the first tube, thereby adjusting a length between the second tube and the first tube, and wherein when the first is rotated, the first tube drives the protruding portion to gradually disengage from the first recessing portion and to abut against the inner wall of the second tube until the first tube and the second tube are in the locking position.

3. (canceled)

4. The tube device of claim 1, wherein the tube device comprises a locating portion to fix the locking base to the first tube, wherein the locating portion comprises a locating bar positioned in an inner surface of the first tube and a locating groove positioned in an outer surface of the locking base to receive the locating bar.

5. The tube device of claim 1, wherein a first hole is defined in a second end of the first tube, and a second hole is defined in an end of the second tube, when the first tube is sleeved to the second tube and the second tube moves from the first end to the second end of the first tube, the first hole is in communication with the second hole.

6. The tube device of claim 5, wherein the tube device comprises a fixing portion defining a fixing hole, wherein when the fixing portion is inserted into the second tube, the second hole is corresponding to the fixing hole.

7. The tube device of claim 6, wherein the fixing portion defines a slot, and the second tube comprises a fixing block protruding out of an inner surface of the second tube, wherein the fixing block is received in the slot.

8. The tube device of claim 1, wherein the locking base comprises an inserting portion locating on an end thereof, and a limiting portion locating another end thereof, wherein when the inserting portion is inserted into the first tube, the limiting portion flushes with an end face of the first tube adjacent to the receiving groove.

9. The tube device of claim 8, wherein the limiting portion defines a third hole in order that atmosphere enters into the tube device.

10. A tripod comprising:
a placing plate; and
a plurality of tube devices engaged to the placing plate, each of the plurality of tube devices comprising:
a first tube;
a second tube sleeved to the first tube, wherein the first tube is received in the second tube; and
a locking member assembled in a sleeve connection position between the first tube and the second tube and received in the second tube;
wherein when the first tube is rotated, the first tube drives the locking member to abut against an inner wall of the second tube until the first tube and the second tube are in a locking position;
wherein the locking member comprises:
a locking plate comprising a protruding portion having a variation thickness, wherein the first tube defines a receiving groove located in first end thereof, and wherein when the locking plate is placed in the receiving groove, the protruding portion protrudes out of the receiving groove; and
a locking base fixed to the first tube and defining a second recessing portion in communication with the receiving groove, wherein the protruding portion is received in the second recessing portion;
wherein when the first tube is rotated, the first tube drives the locking base to rotate, and the locking base drives the protruding portion to gradually disengage from the second recessing portion and to abut against the inner wall of the second tube until the first tube and the second tube are in the locking position.

11. The tripod of claim 10, wherein the locking member comprises a protruding portion having a variation thickness, and the first tube defines a first recessing portion for receiving the protruding portion; wherein when the protruding portion is received in the first recessing portion, the second tube can move relative to the first tube, thereby adjusting a length between the second tube and the first tube, and wherein when the first is rotated, the first tube drives the protruding portion to gradually disengage from the first recessing portion and to abut against the inner wall of the second tube until the first tube and the second tube are in the locking position.

12. (canceled)

13. The tripod of claim 10, wherein the tube device comprises a locating portion to fix the locking base to the first tube, wherein the locating portion comprises a locating bar positioned in an inner surface of the first tube and a locating groove positioned in an outer surface of the locking base to receive the locating bar.

14. The tripod of claim 10, wherein a first hole is defined in a second end of the first tube, and a second hole is defined in an end of the second tube, when the first tube is sleeved to the second tube, and the second tube moves from the first end to the second end of the first tube, the first hole is in communication with the second hole.

15. The tripod of claim 14, wherein each of the plurality of the tube devices comprises a fixing portion defining a fixing hole, wherein when the fixing portion is inserted into the second tube, the second hole is corresponding to the fixing hole.

16. The tripod of claim 15, wherein the fixing portion defines a slot, and the second tube comprises a fixing block protruding out of an inner surface of the second tube, wherein the fixing block is received in the slot.

17. The tripod of claim 10, wherein the locking base comprises an inserting portion locating on an end thereof, and a limiting portion locating another end thereof, wherein when the inserting portion is inserted into the first tube, the limiting portion flushes with an end face of the first tube adjacent to the receiving groove.

18. The tripod of claim 17, wherein The limiting portion defines a third hole in order that atmosphere enters into the tube device.
